(19) United States
(12) Patent Application Publication
(10) Pub. No.: US 2025/0316826 A1
(43) Pub. Date: Oct. 9, 2025

(54) END PLATE ASSEMBLY AND BATTERY MODULE INCLUDING THE SAME

(71) Applicant: LG ENERGY SOLUTION, LTD., Seoul (KR)

(72) Inventors: Hyun Jae LEE, Daejeon (KR); Ji Hwan KIM, Daejeon (KR); Ji Hyung KIM, Daejeon (KR); Dong Su LEE, Daejeon (KR)

(73) Assignee: LG ENERGY SOLUTION, LTD., Seoul (KR)

(21) Appl. No.: 18/708,075

(22) PCT Filed: May 11, 2023
(86) PCT No.: PCT/KR2023/006441

§ 371 Date: Jun. 20, 2025

(30) Foreign Application Priority Data
Jun. 16, 2022 (KR) 10-2022-0073816
Apr. 11, 2023 (KR) 10-2023-0047795

(51) Int. Cl. H01M 50/296; H01M 50/204; H01M 50/289

(52) U.S. Cl. CPC H01M 50/296; H01M 50/204; H01M 50/289

(57) ABSTRACT

A battery module includes a plurality of batteries, and an end plate disposed outside the plurality of batteries and provided with a buffer part at an edge adjacent to elements that are electrically connected to the plurality of batteries.

### TECHNICAL FIELD

### Cross-Reference to Related Application

The present application claims the benefit of the priority of Korean Patent Application Nos. 10-2022-0073816, filed on Jun. 16, 2022, 10-2023-0047795, filed on Apr. 11, 2023, which are hereby incorporated by reference in their entirety.

### TECHNICAL FIELD

The present invention relates to an end plate assembly and a battery module including the same.

### BACKGROUND ART

As the demand for solving the problem of environmental pollution caused by the abuse of petroleum resources and the demand for alternative energy sources to replace fossil energy increase, research and development on power generation based on Eco-friendly energy sources are being conducted. Particularly, researches on secondary batteries capable of being repeatedly chargeable/dischargeable are being actively conducted, and research/development on various aspects such as materials, structures, processes, and stability of secondary batteries are being conducted.

Secondary batteries may be managed in module units. For example, a plurality of secondary batteries may be mounted in a battery module in series/parallel arrangement and managed by a battery management system. There may be various arrangement/management examples according to the type or shape of the secondary battery.

In order to electrically connect the secondary batteries to each other, elements such as a bus bar or a connector may be exposed to the outside, and there is a need to protect the element from an external impact.

According to the prior art, it is difficult to absorb the impact from the outside through a plate defining outer peripheries of the secondary batteries, and thus, the internal elements may be damaged.

### DISCLOSURE OF THE INVENTION

### Technical Problem

An object of the present invention for solving the above problem is to provide an end plate assembly capable of minimizing an external impact and improving structure stability, and a battery module including the same.

### Technical Solution

A battery module according to an embodiment of the present invention includes a plurality of batteries, elements electrically connected to the plurality of batteries and an end plate disposed outside the plurality of batteries, the end plate having a buffer part at an edge adjacent to the elements that are electrically connected to the plurality of batteries.

An end plate assembly according to an embodiment of the present invention includes an insulating cover provided with an element cover part configured to cover elements electrically connectable to a plurality of batteries, and an end plate disposed outside the insulating cover and provided with a buffer part at an edge adjacent to the element cover part.

### Advantageous Effects

According to the preferred embodiment of the present invention, the external impact may be mitigated to improve the elements from being damaged.

According to the preferred embodiment of the present invention, the structural stability may be improved.

### BRIEF DESCRIPTION OF THE DRAWINGS

FIG. 1 is a perspective view of a battery module according to an embodiment of the present invention.

FIG. 2 is an exploded perspective view of an end plate assembly according to an embodiment of the present invention.

FIG. 3 is an enlarged cross-sectional view of a buffer part and an insulating cover according to an embodiment of the present invention.

FIG. 4 is a conceptual view illustrating impact absorption of the buffer part according to an embodiment of the present invention.

### MODE FOR CARRYING OUT THE INVENTION

Hereinafter, preferred embodiments of the present invention will be described in detail with reference to the accompanying drawings so that those of ordinary skill in the art can easily carry out the present invention. However, the present invention may be implemented in several different forms and is not limited or restricted by the following examples.

In order to clearly explain the present invention, detailed descriptions of portions that are irrelevant to the description or related known technologies that may unnecessarily obscure the gist of the present invention have been omitted, and in the present specification, reference symbols are added to components in each drawing. In this case, the same or similar reference numerals are assigned to the same or similar elements throughout the specification.

Also, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

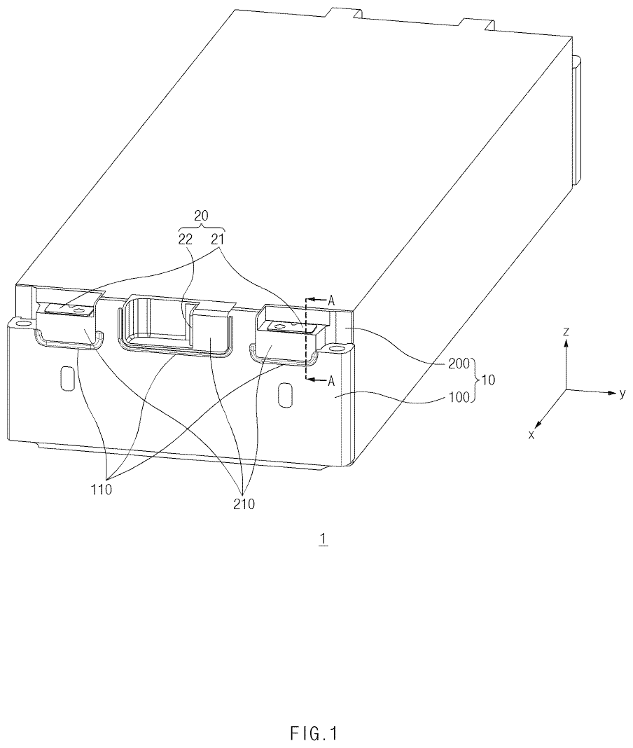

FIG. 1 is a perspective view of a battery module according to an embodiment of the present invention.

A battery module 1 may include a plurality of batteries. The plurality of batteries may be secondary batteries.

The battery module 1 may include a frame 10. The frame 10 may define an outer periphery of the battery module 1 outside the plurality of batteries.

The battery module 1 may include elements 20. The elements 20 may be electrically connected to the plurality of batteries. For example, the elements 20 may be disposed outside the plurality of batteries to electrically connect the outside of the battery module 1 to the plurality of batteries. The elements 20 may include a bus bar 21 and a connector 22.

The frame 10 may include an end plate 100.

The end plate 100 may be disposed outside the plurality of batteries. For example, referring to FIG. 1, the end plate 100 may be disposed on a predetermined plane (e.g., YZ plane) in a predetermined direction (e.g., X-axis direction) from the outside of the plurality of batteries to cover one side of each of the plurality of batteries.

The end plate 100 may include a buffer part 110. The end plate 100 may have a buffer part 110 provided at an edge adjacent to the elements 20 electrically connected to the plurality of batteries. Particularly, for example, when viewed in the X-axis direction, the buffer part 110 may be disposed in a shape surrounding the elements 20. For another example, when viewed in the X-axis direction, the buffer part 110 may be provided in a shape surrounding the elements 20 by being spaced a predetermined distance from the elements 20.

The shape of the buffer part 110 is not particularly limited as described above and may be designed variously within a reasonable range of design changes in the above-described embodiment to protect the elements 20 from an external impact.

The buffer part 110 may include an elastic member. For example, the buffer part 110 may include the elastic member to effectively absorb and alleviate the external impact. However, it is not limited thereto, and there may not be particularly limited as long as the buffer part is a member capable of absorbing an impact.

The buffer part 110 may protrude toward the outside. For example, the buffer part 110 may protrude to a certain extent in the +X direction from the plurality of batteries.

The frame 10 may include an insulating cover 200.

The insulating cover 200 may be disposed between the plurality of batteries and the end plate 100. For example, the plurality of batteries, the insulating cover 200, and the end plate 100 may be sequentially arranged in the +X direction.

The insulating cover 200 may include an element cover part 210. The element cover part 210 may be a portion covering the elements 20 in the insulating cover 200. For example, the element cover part 210 may be disposed to cover at least a direction (e.g., a vertical direction) transverse to the X-axis direction based on the arrangement position of the elements 20. In other words, the element cover part 210 may be provided on a YZ plane to protect the elements 20 from an interference acting in the X-axis direction.

The buffer part 110 may be disposed along an edge of the element cover part 210. For example, the buffer part 110 may protrude in the X-axis direction from a portion corresponding to the edge of the element cover part 210.

As described above, as the buffer part 110 protrudes, the elements 20 may be protected from the external impact.

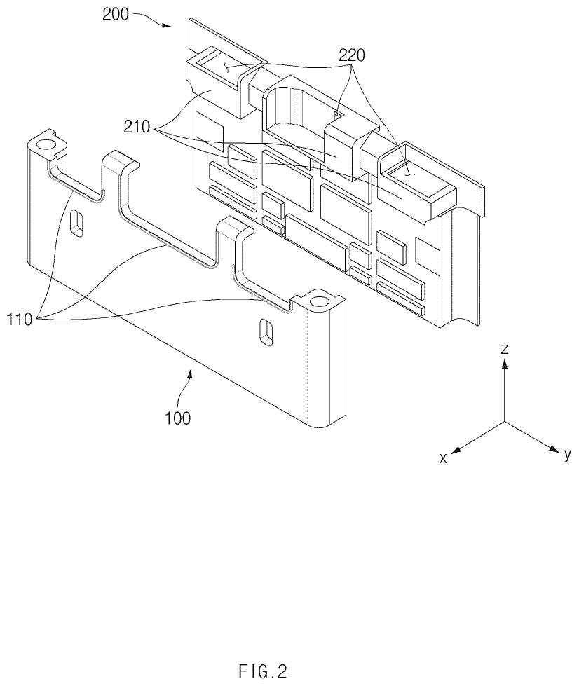

FIG. 2 is an exploded perspective view of an end plate assembly according to an embodiment of the present invention.

An opening 220 may be defined in the insulating cover 200. For example, the opening 220 may be opened toward a direction other than a direction toward the end plate 10. In other words, the opening 220 may be opened in a direction other than the direction toward the end plate 100 (e.g., the +X direction) so that the elements 20 and the external device are electrically connected to each other.

A portion of the insulating cover 200 may be seated on the buffer part 110. Specifically, the element cover part 210 of the insulating cover 200 may be seated on the buffer part 110 protruding outward. Thus, the sagging of the insulating cover 200 may be suppressed to improve structural stability.

The element cover part 210 may protrude outward so as to be seated on the buffer part 110.

The buffer part 110 may be provided discontinuously. For example, the buffer part 110 may be discontinuously provided at the edge of the end plate 100 at the side of each of the elements 20. As the buffer part 110 is provided discontinuously, an effect of impact absorption may be improved even with the minimum buffer part 110.

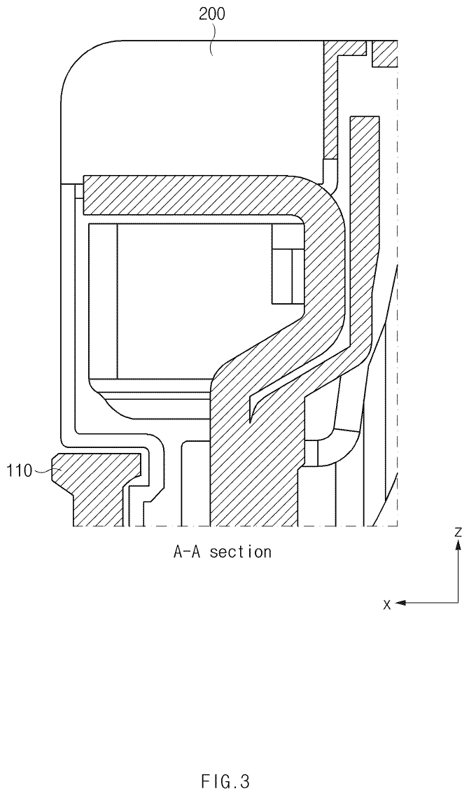

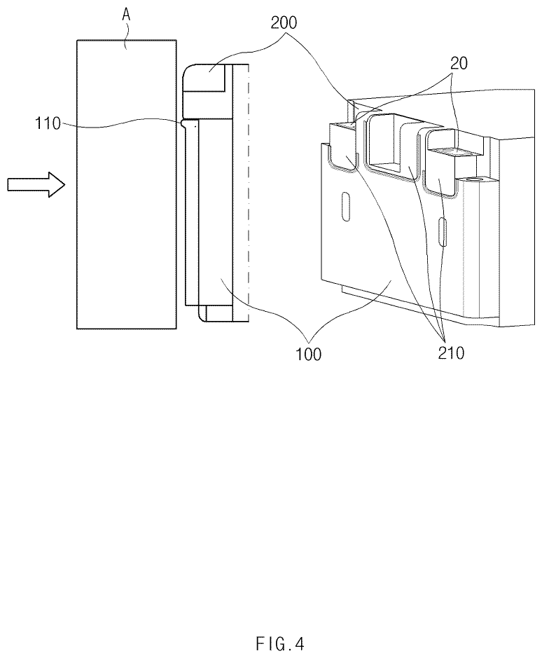

FIG. 3 is an enlarged cross-sectional view of the buffer part and the insulating cover according to an embodiment of the present invention, and FIG. 4 is a conceptual view illustrating impact absorption of the buffer part according to an embodiment of the present invention.

Referring to FIG. 3, the buffer part 110 may protrude more outward than the insulating cover 200. For example, a portion of the insulating cover 200 (e.g., the element cover part 210) also protrudes outward, but the buffer part 110 may protrude more in the +X direction than the insulating cover 200.

As described above, since the buffer part 110 further protrudes, when collision or contact with an external object A occurs, the buffer part 110 may preferentially collide or contact the external object A to absorb an impact.

The above-described collision or contact from the external object A may include pressurization by a cylinder or a jig. In addition, the collision or contact from the external object A may include an unexpected external impact.

The buffer part 110 may have a rib shape.

Referring to FIG. 4, the insulating cover 200 may perform an insulating function to prevent unintended electrical connection other than electrical connection through the elements 20 from occurring.

A portion of the insulating cover 200 may be seated on the buffer part 110 protruding outward to realize structural stability, thereby securing reliability of the insulating function.

The buffer part 110 may support the element cover part 210 of the insulating cover 200. The buffer part 110 may be disposed along the edge of the end plate 100, on which the element cover part 210 is seated, to support the element cover part 210.

The buffer part 110 may be discontinuously provided at a portion of the edge of the end plate 100 that supports the element cover part 210.

When the insulating cover 200 is supported by the buffer part 110, relative movement between the insulating cover 200 and the end plate 100 may be suppressed to improve the structural stability.

While the embodiments of the present invention have been described with reference to the specific embodiments, it will be apparent to those skilled in the art that various changes and modifications may be made without departing from the spirit and scope of the invention as defined in the following claims.

### Description of the Symbols

1: Battery module

10: Frame

20: Elements

21: Bus bar

22: Connector

100: Plate

110: Buffer part

200: Insulating cover

210: Element cover part

220: Opening

1. A battery module comprising:
a plurality of batteries;
elements electrically connected to the plurality of batteries; and
an end plate disposed outside the plurality of batteries, the end plate having a buffer part at an edge adjacent to the elements that are electrically connected to the plurality of batteries.

2. The battery module of claim 1, wherein the buffer part protrudes outward.

3. The battery module of claim 1, further comprising an insulating cover disposed between the plurality of batteries and the end plate, the insulating cover being provided with an element cover part configured to cover the elements.

4. The battery module of claim 3, wherein a portion of the insulating cover is seated on the buffer part.

5. The battery module of claim 3, wherein the buffer part is disposed along an edge of the element cover part.

6. The battery module of claim 3, wherein the insulating cover has an opening so that the elements and an external device are electrically connectable to each other in a direction other than a direction toward the end plate.

7. The battery module of claim 3, wherein the element cover part protrudes outward to be seated on the buffer part.

8. The battery module of claim 3, wherein the buffer part protrudes further outward than the insulating cover.

9. The battery module of claim 1, wherein the buffer part is discontinuously provided at the edge.

10. The battery module of claim 1, wherein the elements comprise at least one of a bus bar and a connector.

11. An end plate assembly comprising:
an insulating cover provided with an element cover part configured to cover elements electrically connectable to a plurality of batteries; and
an end plate disposed outside the insulating cover and provided with a buffer part at an edge adjacent to the element cover part.

12. The end plate assembly of claim 11, wherein a portion of the insulating cover is seated on the buffer part.

13. The end plate assembly of claim 11, wherein the buffer part protrudes outward.

14. The end plate assembly of claim 13, wherein the buffer part protrudes further outward than the insulating cover.
